(19) United States
(12) Patent Application Publication
(10) Pub. No.: US 2009/0222912 A1
(43) Pub. Date: Sep. 3, 2009

(54) IDENTIFICATION DEVICE AND AUTHENTICATION METHOD THROUGH SUCH A DEVICE

(76) Inventor: Luigi BOSCHIN, ALDESAGO (CH)

Correspondence Address: LUCAS & MERCANTI, LLP, 475 PARK AVENUE SOUTH, 15TH FLOOR, NEW YORK, NY, 10016, US

(21) Appl. No.: 12/255,961

(22) Filed: Oct. 22, 2008

(30) Foreign Application Priority Data
Feb. 29, 2008 (CH) 0304/08

(51) Int. Cl. G06F 17/30; H04L 9/32

(52) U.S. Cl. 726/19; 707/104.1; 707/E17.009

(57) ABSTRACT

An identification device comprises a seat for containing a sample of biological material and at least one storage support suitable for containing a record in electronic format of the DNA. An authentication method compares the record of the sample of DNA with the one stored in said support.

### CROSS-REFERENCE TO RELATED APPLICATIONS

This application claims the benefit of priority from Swiss patent application serial number 0304/08 filed Feb. 29, 2008, the contents of which are incorporated herein by reference.

### DESCRIPTION

1. Field of Application

The present invention refers to a device to be used to confirm the identity of a person. The invention also refers to an authentication method that can be also used in situations in which a person has disappeared or cannot be found.

2. Prior Art

Different systems for determining the identity of a person are known, which are more or less complex and have different degrees of reliability according to the situation in which they have to operate.

For example, systems are known that are based upon a secret code and/or password, including the recent public and private key systems used to encode secret communications, but which are substantially useful for exchanging messages only, and are ineffective in the case of key theft.

So-called biometric systems are also known that are based, for example, upon the identification of digital prints, of the retina, etc . . . and are generally used to manage access to reserved areas or data, for example biometric digital print readers are incorporated for this purpose in a personal computer. These systems are considered to be very reliable and difficult to cheat; however, they require the physical presence of the person.

Recently, moreover, various improvements to common personal identification cards, like identity cards or similar, have become widespread, for example plasticised cards that carry a photograph, a digital print of the person, a microchip or a magnetic strip containing further information. These cards are intended substantially for police, customs or similar checks, in which they are presented by the person himself. The presence of digital prints, microchips, etc., in addition to the photograph, makes it more difficult to fake.

Following recent developments in DNA analysis techniques, it has also been proposed to create databases of the genetic profile of people, substantially as a crime-tackling tool, i.e. in order to keep a record of people with criminal records.

With regard to this prior art, a problem that is still unsolved is that of determining the intentions and/or the wishes of a person when the person himself has disappeared, died or deemed as such, or in any case cannot be found.

Such a problem presents itself, for example, at the start of will proceedings, especially if there are doubts over the legitimate heirs and/or the actual wishes of the deceased person. Similarly, such a problem can occur in finance and/or banking for example when it is necessary to determine the legitimacy of an heir.

In such a situation the aforementioned systems are inapplicable or do not ensure a sufficient level of reliability. In will proceedings or in banking, for example, it would be good to have an absolutely certain authentication system, whereas the known systems listed above, although with different levels of difficulty, can still be tricked.

### SUMMARY OF THE INVENTION

The technical problem forming the basis of the present invention is to devise and provide a method and relative identification and/or authentication device capable of overcoming the aforementioned limitations of the prior art, in particular also able to be used in the person's absence and/or after his death.

The idea forming the basis of the present invention is to determine the identity of a person by providing a record in electronic format of his DNA, able to be compared with a sample of the DNA itself.

The problem outlined above, therefore, is solved with a device comprising at least one seat for containing a sample of biological material of a person, and at least one storage support suitable for containing a record of the DNA (DNA-imprint) of the person.

By the term imprint or record we mean the result, in numerical form, of a DNA sequencing operation carried out with techniques that are per se known and therefore not described any further. Said imprint or record is intended to be unequivocally linked to the original DNA.

Preferably, the device also comprises a further storage support, for example a RAM memory, to contain further data, advantageously encrypted so as not to be able to be modified by third parties.

According to a further aspect of the invention, the sample of biological material is contained in a separable portion of the body of the device, which can be removed to make it easier to analyse the sample itself.

According to the invention, therefore, an authentication method is provided comprising determining the identity of a person through the following steps:
providing a sample of biological material in an authentication device;
providing at least one electronic DNA record stored in said device;
extracting a record of the DNA of said sample of biological material contained in the device;
comparing said record extracted from the sample of biological material with the record stored in the device itself.

The invention provides a safe identification method, since the DNA profile is unique for each individual. In particular, the comparison between the record stored (in numerical format) and the record extracted from the sample represents a practically infallible test, much safer for example than current biometric systems based upon digital prints, retina, etc . . .

Another substantial advantage of the invention is that the device, thanks to the memory incorporated and to the sample of biological material contained in it, provides an amount of data that—through the cross-checking of the numerical record of the DNA with the sample—can be attributed with certainty to the “owner” of the device, even if he is absent, uncontactable or deceased.

The invention, as shall be understood, is useful in many situations like for example will proceedings, kinship tests, etc . . . Moreover, the provision of the DNA code, in quickly accessible form, can also be useful in emergency situations for example to determine compatibility between donor and receiver for a transplant.

The invention can therefore successfully replace the current systems for filing wills, for filing private documents at banks, and so on, with improved reliability.

The invention can also be used as a commemorative object containing images, texts and other information. Regarding this, according to another aspect of the invention, the device can be made in the form of a commemorative object, or incorporated in it, for example a painting.

The advantages of the invention shall become clearer with the help of the following description, referring to a preferred embodiment.

### BRIEF DESCRIPTION OF THE DRAWINGS

FIG. 1 represents a diagram of a device according to the invention.

FIG. 2 represents a diagram of a device according to another embodiment of the present invention.

FIG. 3a-3d schematically represent the steps of the authentication method according to the present invention.

### DETAILED DESCRIPTION OF A PREFERRED EMBODIMENT

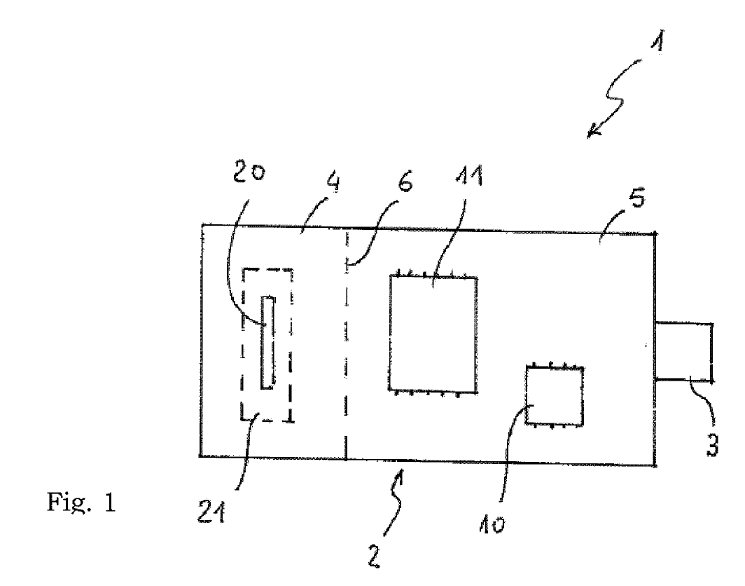

With reference to the diagram of FIG. 1, an identification device according to the invention is generally indicated with 1. Such a device 1, in the example, is made in the form of a memory device (stick) comprising a body 2 and a communication port 3. The body 2 is made from plastic material, divided into two sections 4 and 5, separated by a cutting line 6.

The communication port 3 is suitable for allowing data to be received and sent preferably according to a suitable per se known standard, for example USB.

A read-only memory (ROM) device (chip) 10 and a random access memory (RAM) device 11, accessible through the port 3, are incorporated into the section 5 of the device 1. Further accessory circuitry is not illustrated, and should be made according to the prior art as instance the common USB sticks.

According to the invention, the read only memory chip 10 contains a unique code (record) of a person's DNA, obtained with a per se known algorithm that is preferably encoded (encrypted).

The random access memory chip 11, according to the invention can contain further information linked to the person as well as files of any type, including documents, images, etc. Such information and/or files can also include the person's wishes, for example representing a will. Advantageously, this further data is also encrypted so as not to be able to be modified by third parties and/or to keep a record of possible changes, all with computing techniques that are per se known.

Section 4 of the device 1 contains a sample of DNA or biological material generally indicated with 20 of the same person, inside a containment seat 21.

Such a containment seat 21 can be formed in the body 2 of the device and sealed after the introduction of the sample 20. Such a sample 20 is preferably subjected to a per se known stabilisation process, before being incorporated in the device 1.

As an example, the sample 20 can be represented by an organic liquid or liquid preparation containing organic material, which is absorbed and dried in a sterile environment on a suitable porous matrix, trapping the organic material (containing the genetic code) in the matrix itself. Other embodiments are possible, for example with the sample 20 inserted in a small metallic or plastic container that is sealed and in turn incorporated in the body 2. The cutting line 6 allows the section 4 to be separated for removal of the sample 20 and its analysis.

According to a further variant, the device can be made from metal for greater mechanical strength and for a longer lifetime; preferably, the device is further screened to preserve the data, e.g. from external radiation that could delete or alter it.

Further embodiments comprise, for example, the device in the “credit card” format, instead of USB stick. Clearly, the device can be made in any other form, preferably but not necessarily small in size so as to be portable.

Its use is the following. The device 1 can be kept on one's person as a personal item, or else filed in a special depository or even in a bank, for example in a safe-deposit box.

When needed, the portion 4 of the device 1 is separated, and the sample 20 is removed from the seat 21. Said sample 20 is analysed, obtaining a record to be compared with the record electronically stored in the memory 10.

The legitimate owner of the device 1 may claim the ownership of the device by furnishing another sample of his DNA which is analysed, obtaining a further record to be compared with the record obtained by the sample 20 and with the record electronically stored in the memory 10.

If all the records match, the device 1 can be given with certainty to the legitimate owner of the device itself.

In the same way, if the legitimate owner deceased, one of his heirs may claim the device 1 by furnishing a sample of his DNA which is analysed, obtaining the heir's record to be compared with the record obtained by the sample 20 and with the record electronically stored in the memory 10. In this case, the heir's record is not identical to the other records but it is sufficient to establish the kinship and to let or deny the heir to access the information stored in the device 1.

In this way, there is a secure authentication of the information contained in the random access memory 11, which can be sensitive and/or commemorative information.

The device can be successfully used to resolve legal questions like determining kinship and parenthood, heirs for will proceedings, and similar. Indeed, it provides a sample of a person's DNA, even if the person has disappeared, deceased or cannot be contacted, and through testing of the match between the electronic data and the sample, has a very high degree of reliability. In a further application, the device 1 is incorporated in a commemorative object, for example a painting of the deceased person, in which for example the communication port with the outside is located on the frame. In this way, it is possible to display photographs, films, or other, contained in the memory 11.

According to another embodiment of the present invention, the device is used also for secure communication and for authentication method, as it will be explained in the following description.

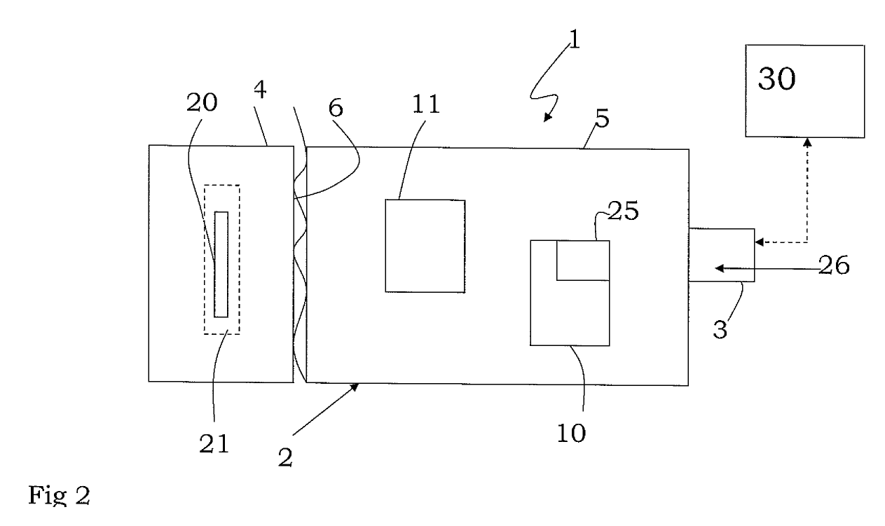

Inside the read-only memory (ROM) device (chip) 10, a cryptographic asymmetric algorithm 25 is further stored, as schematically represented in FIG. 2, for instance an RSA or a DSA algorithm, which generates a couple of public/private keys, i.e. more than one, used for implementing secure communications between the identification device 1 and, for example, a host device 30 connected thereto, via the communication port 3.

The host device 30 may be, for instance, a secured server 30 with limited access to authorized persons of an organization furnishing data storage.

An example of secure communication between the secure server 30 and the device 1, given only for illustrative purpose and without limiting the scope of protection of the present invention, is given here below.

The cryptographic asymmetric algorithm 25 generates the couple public/private keys and the device 1 sends the public key to the host device 30, via the port 3, in order to establish a secure communication.

The host device 30 receives the public key, encrypts a message to be delivered to the device 1 with the public key there from received and sends the encrypted message to the identification device 1. The identification device 1 receives the encrypted message and decrypts it using the private key, which is the unique key able to decrypt the message encrypted with the public key.

According to the present invention, the cryptographic asymmetric algorithm 25 receives in input the record in electronic format of the person's DNA and generates in output the couple of public/private keys.

The record is processed with a software suitable to analyse a sample of the person's DNA, for example a KitPowerPlex 16 System of Promega, and is stored in the read-only memory (ROM) device chip 10 of the device 1.

More particularly, the record of person's DNA comprises a vector 26 of allele values wherein each allele value belongs to a predetermined range representative of a corresponding locus of the person's DNA.

Table 1 below reports, in column 1, the names of the loci of the person's DNA and, in column 2, the corresponding admissible range of values, given only for example and not limited to the number or loci considered. Preferably, the vector 26 also includes the locus “Amel” which is associated to the value “XX”, if the person's gender is female, and to the value “XY”, otherwise.

TABLE 1

| Loci | Allele (from . . . to) |
|---|---|
| D3S1358* | From 12 to 20 |
| TH01* | From 4 to 13.3 |
| D21S11* | From 24 to 38 |
| D18S51* | From 8 to 27 |
| Penta E | From 5 to 24 |
| D5S818 | From 7 to 16 |
| D13S317 | From 7 to 15 |
| D7S820 | From 6 to 14 |
| D16S539* | From 5 to 15 |
| CSF1P0 | From 6 to 15 |
| Penta D | From 2.2 to 17 |
| Amel. | XX or YY |
| vWA* | From 10 to 22 |
| D8S1179* | From 7 to 18 |
| TPOX | From 6 to 13 |
| FGA* | From 16 to 46.2 |

A vector 26 of allele values, for a male person, may be, for example, “15-17; 6-9.3; 29-30; 14-16; 12-21; 11-14; 12-12; 9-9; 8-11; 10-11; 9-11; XY; 16-18; 13-14; 8-9; 23-23”.

The cryptographic asymmetric algorithm 25 generates, as output, the couple of public/private keys which, advantageously, result strictly associated and directly derivable from the person's DNA and the cryptographic asymmetric algorithm 25 used for their generation.

Advantageously, the public key stored in the identification device 1 may be used to encrypt a plurality of reserved data including secret documents, religion or political belief, medical information, banking accounts, secret images, person's wishes, wills, etc which may be stored in the secured server 30 and cannot be decrypted without the corresponding private key, which is kept secret inside the identification device 1.

The identification device 1 according to the present invention is advantageously used for implementing an authentication method comprising the following steps:
providing a sample of the person's biological material in the device;
storing at least one record in electronic format of DNA of the person is stored in the device.

The method further comprises a cryptographic asymmetric algorithm which is executed, receiving in input the record in electronic format of DNA and generating in output a couple of public/private keys.

The method further comprises the steps of obtaining the record of the DNA of the sample of biological material contained in the device and comparing the record obtained from the sample of biological material with the record stored in the device itself.

The step of generating the couple of public/private keys in cryptographic asymmetric algorithm is stopped if the step of comparing result in the record obtained from the sample of biological material is different from the record stored in the device itself.

Advantageously, the cryptographic asymmetric algorithm and the couple of public/private keys described above may be used for a plurality of applications requiring security, for example for authentication applications in data banking system, for digital signature applications, for storing data in encrypted form in a server data storage.

Advantageously, according to the present invention, the authentication is enforced because the public/private keys are generated by the cryptographic asymmetric algorithm only if the record obtained from the sample of biological material is equal to the record stored in the device.

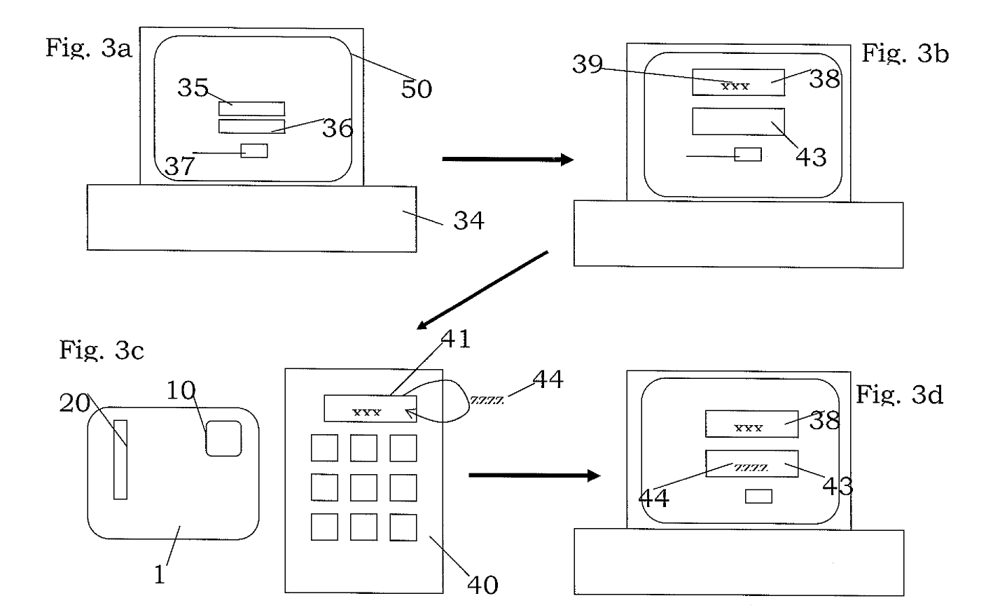

With reference to FIG. 3a-3d is hereafter described an embodiment of the authentication method according to the present invention.

A person wishes to access reserved data stored in a secure server 30 and comprising, for example, secret documents, medical information, secret images, person's wishes, banking accounts, etc . . . These data are encrypted according to the public key of the identification device 1, which, as described above, may be in the form of a credit card.

As schematically represented in FIG. 3a, the person connect a personal computer 34 to the secured server 30 via the Internet, for example specifying an internet address associated to the server 30. Without limiting the scope of the present invention, the person may connect to the server 30 using any other electronic device, such as a PDA or a phone, provided with per se known communications interfaces towards the server 30. The secured server 30 returns to the person's personal computer a login page 50 including a username field 35 and a password field 36 wherein the person may insert his own credentials, including his personal username “AAA” and password “BBB”, which are previously sent to the person by the organization furnishing data storage, together with a personal's reader of the device 1. The personal's reader 40 may be in the form of a calculator including a slot wherein the credit card 1 may be introduced.

After the credentials are entered in the login page 50, the secured server 30 executes an application which returns, in a filed 38 of the login page, an access code 39, for example an alphanumeric code “XXX”, as schematically represented in FIG. 3b. The secured server 30 process the access code 39 by an execution on an algorithm “Algx” taking in input at least the person's DNA and the user's credentials, which are also stored in the secured server 30. As described in FIG. 3b, the login page may be reloaded before returning the access code 39, in order to display only the access code 39.

The person inserts the credit card (device 1) inside the personal's reader 40, digits the access code 39 returned by the secured server 30 and selects a process button on a keyboard of the reader, as schematically represented in FIG. 3c. The personal's reader 40 process a second access code 44, for example another alphanumeric code “zzzz” and returns it on a display 41 of the personal's reader 40.

More particularly, the personal's reader 40 processes the second access code 44 by the execution of an algorithm “Algz” which takes in input the user's credentials, the access code 39 provided by the secured server 30 and the person's DNA record provided by the credit card 1. More particularly, the user's credentials are stored in the memory 10 of the credit card 1.

In order to complete the login in the secured server 30 and for accessing the secured data, the person inserts the second access code in a field 43 of the login page and confirms his authentication.

Advantageously, the authentication according to the present invention enforce security because it is based not only on username and password, but also on a first 39 and a second 44 access code which are respectively generated by the secured server 30 and the personal's reader 40 on the base of the credential and the personal's DNA record, which are strictly associated to the user.

1. An identification device comprising:
a seat for containing a sample of biological material of a person;
at least one storage support suitable for containing a record in electronic format of the person's DNA.

2. Device according to claim 1, wherein said storage support further comprises a cryptographic asymmetric algorithm suitable for generating a couple of public/private keys from the record in electronic format of the person's DNA.

3. Device according to claim 1, wherein said storage support is a ROM memory device.

4. Device according to claim 1, also comprising a reading and writing memory device and an interface for accessing such a memory device.

5. Device according to claim 1, wherein said seat for containing the sample of biological material is associated with a separable portion of the body of said device.

6. Device according to claim 5, wherein said separable portion is joined to the remaining portion of the body of the device through a cutting line.

7. Device according to claim 1, characterised in that it is portable and structured like a USB stick or a credit card or similar.

8. Device according to any claim 1, characterised in that it is made from plastic material or screen-coated metallic material, to protect the data from external radiation.

9. An authentication method comprising the following steps:
providing a sample of a person's biological material in an authentication device; and
providing at least one record in electronic format of DNA of said person stored in said device;

10. Authentication method according to claim 9 characterized by comprising the step of executing a cryptographic asymmetric algorithm in said device for generating a couple of public/private keys.

11. Authentication method according to claim 10 characterized by providing in input to the cryptographic asymmetric algorithm said record in electronic format of DNA.

12. Authentication method according to claim 10 wherein said record in electronic format comprises a vector of allele values.

13. Authentication method according to claim 12 further comprising the steps of:
obtaining the record of the DNA of said sample of biological material contained in the device and
comparing said record obtained from the sample of biological material with the record stored in the device itself.

14. Authentication method according to claim 13 wherein said step of executing the cryptographic asymmetric algorithm is ended without generating the couple of public/private keys if the compared records are different.
